(19) United States
(12) Patent Application Publication
(10) Pub. No.: US 2008/0165385 A1
(43) Pub. Date: Jul. 10, 2008

(54) MULTI-FUNCTION DEVICE SYSTEM HAVING MULTI-FUNCTION DEVICE AND MULTI-FUNCTION DEVICE COMMUNICATIONS MANAGEMENT UNIT, MULTI-FUNCTION DEVICE, AND MULTI-FUNCTION DEVICE COMMUNICATIONS MANAGEMENT UNIT

(75) Inventor: Satoshi KOTAKA, Azumino-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 11/971,345

(22) Filed: Jan. 9, 2008

(30) Foreign Application Priority Data
Jan. 10, 2007 (JP) 2007-002134

(51) Int. Cl. G06F 15/00

(52) U.S. Cl. 358/1.15

(57) ABSTRACT

A multi-function device system is provided, which includes a multi-function device and a multi-function device communications management unit, in which the use efficiency of the memory provided in a facsimile unit is enhanced and data printed in divided form can be saved as one-page data in the multi-function device communications management unit. More precisely, the multi-function device system includes a multi-function device and a multi-function device communications management unit, wherein the multi-function device is connected to a network and has a facsimile function and the multi-function device communications management unit is connected to the same network and saves the backup data of document data that the multi-function device has received by facsimile. In the multi-function device, the document data received by facsimile as one-page data is divided into a plurality of pages and printed when the documents data is too large to print on one page. The multi-function device communications management unit is controlled to transmit the backup data of the plurality of pages to the multi-function device communications management unit and to save the backup data of a plurality of pages transmitted from the multi-function device, as one-page backup data.

### CROSS-REFERENCE TO RELATED APPLICATIONS

This application is based upon and claims the benefit of priority from prior Japanese Patent Application No. 2007-2134, filed Jan. 10, 2007, the entire contents of which are incorporated, by reference, in the specification, drawings and abstract.

### BACKGROUND OF THE INVENTION

1. Field of the Invention

The present invention relates to a multi-function device that has a printer function of printing data on recording media, a scanner function of reading data from original documents, and a facsimile function of transmitting and receiving facsimile documents. The present invention also relates to a method of controlling a multi-function device communications management unit that manages the facsimile function of the multi-function device.

2. Description of the Related Art

A device is available, which is known as digital multifunction device (hereinafter referred to as multi-function device). The multi-function device has a scanner function of reading data from original documents, a printer function of printing data on recording media, and a copier function of copying, by using a printer, the images that a scanner has read. In recent years, a type of a multi-function device has come into use, which has an additional function, i.e., a facsimile function of transmitting and receiving facsimile documents.

Known as a multi-function device of this type, which incorporates a facsimile function of transmitting in addition to the other functions, is an embedded type that has a function of saving a backup of any printed facsimile documents. On the other hand, a system (including a facsimile server and a facsimile communications management unit) is disclosed in, for example, Patent Document 1 (JP-A-2006-6979). This system is a device that works independently of a multi-function device having a facsimile function of transmitting and receiving facsimile documents. The system receives facsimile document data and transfers the data to a personal computer or the like that is connected via a network to the multi-function device, so that a backup of the communication history may be saved in the personal computer or the like.

As pointed out above, the multi-function device of embedded type incorporates the function of saving a backup of received facsimile documents. Therefore, once the facsimile documents the device has received is printed, the data of these documents would not be transmitted to facsimile severs or facsimile communications management units existing on the network.

By contrast, in the system disclosed in Patent Document 1, which includes a facsimile server and a facsimile communications management unit, after the multi-function device has printed the received facsimile document data, the data is transferred to the facsimile server or the facsimile communications management unit and is saved therein.

In the multi-function device, if a one-page facsimile document data received is too large to be printed on one printing paper sheet, the one-page document data must be divided into several parts and these data parts must be printed on some printing paper sheets. Even in this case, the data must be saved as one-page data in the facsimile server or in the facsimile communications management unit, because the server and unit are designed to store data in the form of electric data. Here arises a problem. The system has no function of saving the data parts as one block of data, because it includes a conventional facsimile server and a conventional facsimile communications management unit.

On the other hand, the process of dividing one-page document data in the printer unit of the multi-function device and the process of saving the data from the device to the facsimile sever (or the facsimile communications management unit) may be sequentially performed. In this case, however, the received facsimile document data must be stored for a long time. This lowers the use efficiency of the memory. (The memory may fail to store all facsimile document data received next.)

### SUMMARY OF THE INVENTION

In order to solve the problems described above, the present invention provides a system, in which the divided printing process in the printer unit and the process of saving data in an facsimile server or facsimile communications management unit are performed in parallel, and the data printed in divided form is saved as one page in the facsimile server or facsimile communications management unit. A multi-function device system according to the present invention includes a multi-function device and a multi-function device communications management unit. The multi-function device is connected to a network and has a facsimile function. The multi-function device communications management unit is connected to the same network and saves the backup data of document data the multi-function device has received by facsimile. The multi-function device is controlled to divide the document data received by facsimile as one-page data, into a plurality of pages, to print these pages, when the documents data is too large to print on one page. The multi-function device communications management unit is controlled to transmit the backup data of the plurality of pages to the multi-function device communications management unit and to save the backup data of a plurality of pages transmitted from the multi-function device, as one-page backup data.

The multi-function device system according to the present invention, which includes a multi-function device and a multi-function device communications management unit, is characterized in that data related to an overlapping margin exists at the head of the data following the second page of the plurality of pages.

The multi-function device system according to the present invention, which includes a multi-function device and a multi-function device communications management unit, is characterized in that the multi-function device gives information about the width of the overlapping margin to the multi-function device communications management unit.

The multi-function device system according to the present invention, which includes a multi-function device and a multi-function device communications management unit, is characterized in that the multi-function device communications management unit performs a control, thereby removing the data about the overlapping margin from the backup data of the plurality of pages transmitted from the multi-function device and then saving the backup data as one-page backup data.

The multi-function device system according to the present invention, which includes a multi-function device and a multi-function device communications management unit, is characterized in that the multi-function device communications management unit performs a control, thereby saving only that part of the backup data, which has not been saved, out of the backup data of a plurality of pages transmitted from the multi-function device.

The multi-function device system according to the present invention, which includes a multi-function device and a multi-function device communications management unit, is characterized in that a printing error occurs in the multi-function device, a printing process and a process of transmitting the backup data to the multi-function device communications management unit are interrupted.

The multi-function device system according to the present invention, which includes a multi-function device and a multi-function device communications management unit, is characterized in that when the printing error is eliminated in the multi-function device, the printing process and a process of transmitting the backup data to the multi-function device communications management unit are resumed.

A multi-function device according to the present invention is designed to be connected to a network. The multi-function device is characterized in that when document data received as one page is too large to print on one page, the device divides the document data received by facsimile as one-page data, into a plurality of pages, prints these pages, sets data about the overlapping margin at the head of the data following the second page, and transmits the backup data of the plurality of pages, together with the data about the margin, to a multi-function device communications management unit that is connected to the same network.

The multi-function device according to this invention is characterized in that it gives information about the width of the overlapping margin to the multi-function device communications management unit.

A multi-function device communications management unit according to the present invention is characterized in that it receives information about the width of a overlapping margin from a multi-function device and removes data about the overlapping margin from the backup data of a plurality of pages transmitted from the multi-function device, thereby saving the backup page of one page, said multi-function device being configured to receive document data by facsimile as one page, to print the document data as a plurality of pages when the document data is too large to print on one page, to set data about the overlapping margin at the head of the data following the second page, and to transmit the backup data of the plurality of pages.

In the present invention, the received facsimile document data is never held in a memory the facsimile unit unnecessarily for a long time. This increases the use efficiency of the memory. Therefore, the speed of printing the received facsimile document data will not be lowered. Moreover, in the present invention, the data printed in a divided form can be saved as one-page data in the multi-function device communications management unit.

### BRIEF DESCRIPTION OF THE DRAWINGS

FIG. 1 is a diagram showing the configuration of a system according to an embodiment of the present invention, the system including a multi-function device and a multi-function device communications management unit;

FIG. 2 is a diagram showing an original document to be transmitted from a facsimile apparatus provided at a transmission source;

FIG. 3 is a diagram showing the data of the document shown in FIG. 2, which has been read by the facsimile apparatus provided at a transmission source and which has been dulled;

FIG. 4 is a diagram showing two data parts (FIG. 3) that are printed on two paper sheets (A) and (B), respectively, in the multi-function device;

FIG. 5 is a diagram illustrating ideal backup data of dulled data;

FIG. 6 is a chart depicting a control sequence performed by the multi-function device and the multi-function device communications management unit, both according to the present embodiment;

FIG. 7 is a chart depicting the timing of the operations performed under the control of the multi-function device and the multi-function device communications management unit, both according to the present embodiment;

FIG. 8 is a flowchart explaining how a control unit operates to print a received facsimile document in the multi-function device according to the present invention;

FIG. 9 is a flowchart explaining a sequence of control performed to save facsimile backup data in the multi-function device communications management unit according to the present invention;

FIG. 10 is a chart depicting another control sequence performed by the multi-function device and the multi-function device communications management unit, both according to the present embodiment;

FIG. 11 is a flowchart explaining how the facsimile unit receives data in the multi-function device according to the present invention;

FIG. 12 is a flowchart explaining a sequence of control performed to save the facsimile backup data, when data is divided in the multi-function device communications management unit according to the present invention;

FIG. 13 is another chart depicting the timing of the operations performed under the control of the multi-function device and the multi-function device communications management unit, both according to the present embodiment; and

FIG. 14 is a diagram explaining the data-dividing process performed in the facsimile unit provided in the multi-function device according to the present invention.

### DETAILED DESCRIPTION OF THE PREFERRED EMBODIMENTS

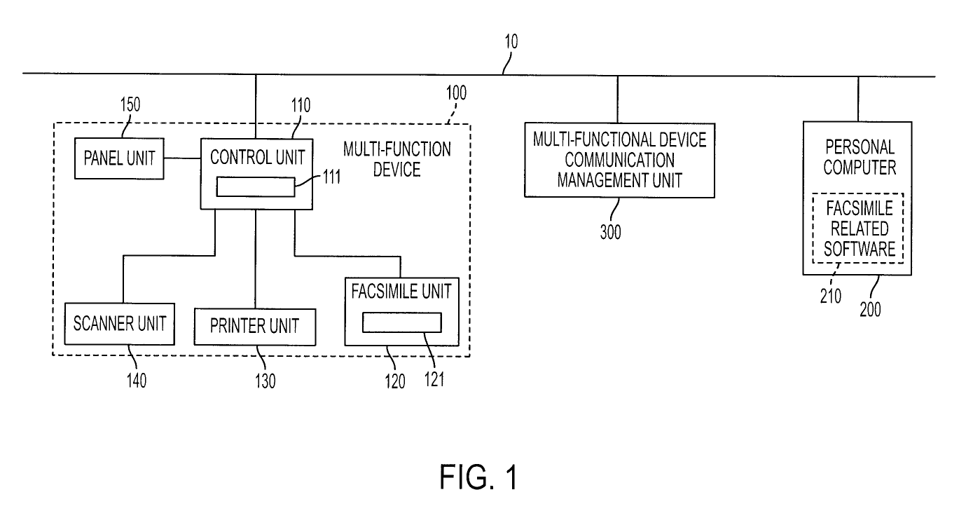

An embodiment of the present invention will be described with reference to the accompanying drawings. FIG. 1 is a diagram showing the configuration of a system of a multi-function device and a multi-function device communications management unit according to an embodiment of the present invention. In FIG. 1, numeral 10 indicates a network such as LAN, WAN or the like, numeral 100 indicates a multi-function device, numeral 110 indicates the control unit performing main control in the multi-function device 100, numeral 111 indicates the memory provided in the control unit 110, numeral 120 indicates a facsimile unit that receives and transmits facsimile documents, numeral 121 indicates a memory provided in the facsimile unit 120, numeral 130 indicates a printer unit that prints data on recording media, numeral 140 indicates a scanner unit that reads data from original documents, numeral 150 is a panel unit that functions as interface with the user of the system, numeral 200 indicates a personal computer, numeral 210 indicates facsimile-related software, and numeral 300 indicates a multi-function device communications management unit.

In the system according to this invention, the network 10 connects the multi-function device communications management unit 300, personal computer 200 (e.g., a client) and digital multi-function device 100 (hereinafter called multi-function device). A plurality of personal computers 200 and a plurality of multi-function devices 100 can be connected to the multi-function device communications management unit 300.

The multi-function device 100 includes the control unit 110, facsimile unit 120, printer unit 130, scanner unit 140, and panel unit 150. The control unit 110 is a data-processing unit and controls the other units of the multi-function devices 100. The panel unit 150 is an input/output apparatus that receives inputs the user has generated. The scanner unit 140 scans original documents, reading data from the original documents. The printer unit 130 prints data on recording media. The facsimile unit 120 receives and transmits facsimile documents. The multi-function device 100 therefore has a copier function of scanning data and printing data and a facsimile function of receiving and transmitting facsimile data.

The multi-function device communications management unit 300, the personal computers 200, and the multi-function device 100 have a data-processing unit each. The data-processing unit is composed of a general-purpose computer system. The components of each data-processing unit perform their functions by executing the computer programs written in a storage means.

The facsimile unit 120 includes a facsimile receipt/transmission unit (not shown), a transmission buffer, a reception buffer and a facsimile memory 121. The facsimile receipt/transmission unit is connected to the public communications line (not shown) and can receive and transmit facsimile data. The facsimile memory 121 constitutes a transmission buffer and a reception buffer. The transmission buffer temporarily stores transmission data that will be transmitted by the facsimile receipt/transmission unit. The reception buffer temporarily stores reception data that has been received by the facsimile receipt/transmission unit. The facsimile memory 121 can store a communication result log that is data representing the results of the receiving and transmitting of data.

When the facsimile unit 120 receives the image data the scanner unit 140 has read, from the control unit 110, the image data is temporarily stored in the facsimile memory 121. The facsimile unit 120 transmits the image data by facsimile. After the image data has been thus transmitted, the data stored in the facsimile memory 121 is erased.

Assume that the facsimile unit 120 receives data sent by facsimile through the public communications line. Then, the received data is temporarily stored in the facsimile memory 121. The received data stored in the facsimile memory 121 is sent from the facsimile memory 121 to the control unit 110. The printer unit 130 prints this data. The timing, at which this data is erased from the facsimile memory 121 after having been printed by the printer unit 130, is controlled as will be explained later.

The facsimile unit 120 receives and transmits facsimile data, operating independently of the other units provided in the multi-function device 100. More specifically, upon receiving transmission data from the control unit 110, the facsimile unit 120 performs facsimile transmission, independently of the multi-function device 100. If facsimile data is transmitted via the public communications line, the facsimile unit 120 receives this facsimile data. Thus, even if any trouble develops on the network 10, the facsimile unit 120 can receive and transmit facsimile data as will be described later, notwithstanding such a trouble.

The multi-function device 100 includes an interface (not shown) and the control unit 110. The interface communicates with the multi-function device communications management unit 300 and the like through the network 10. The control unit 110 controls the panel unit 150, the scanner unit 140, the printer unit 130, and the facsimile unit 120.

The interface for the network 10 transmits a communication result log and facsimile data (transmission data and reception data) to the multi-function device communications management unit 300.

The control unit 110 receives a facsimile transmission instruction from the panel unit 150 and instructs the scanner unit 140 to read image data. The control unit 110 then acquires the image data that the scanner unit 140 has read. The image data is stored in the control memory 111 that is provided in the control unit 110. Further, the control unit 110 acquires the received data that the facsimile unit 120 has received from the public line network. This data is stored in the control memory 111, too, and is transmitted to the printer unit 130. In the present invention, the control memory 111 has a storage capacity that is large enough to store at least one-page data. Indeed the multi-function device communications management unit 300 is equivalent to such a facsimile server or such a facsimile communications management unit as described above in Description of the Related Art. However, the unit 300 will be called “multi-function device communications management unit.” This is because the unit 300 manages the communication related to the multi-function device 100. Note that the “multi-function device communications management unit” according to this invention means both the conventional facsimile server and the conventional facsimile communications management unit.

The multi-function device communications management unit 300 is constituted by a general-purpose computer system such as a personal computer. The unit 300 executes the programs installed in it, performing its function.

The multi-function device communications management unit 300 includes an interface, a communication result log unit (not shown), and a backup data memory unit (not shown, either). The interface is connected to the network 10 and performs communication with the personal computer 200 and the multi-function device 100, both connected to the network 10.

The interface for the network 10 of the multi-function device communications management unit 300, receives communication data and facsimile data, both transmitted from the multi-function device 100. The communication data that the interface for the network 10 has received is stored in the communication result log. The facsimile data that the interface has received is stored in the backup data memory unit. When the interface for the network 10 receives data from the multi-function device 100, the unit 300 transmits a reception acknowledgement to the multi-function device 100.

The multi-function device communications management unit 300 may be configured to store not only the communication data and the facsimile data, both coming from the multi-function device 100, but also the image data that the scanner unit 140 has scanned and read in the multi-function device 100. The communication data and the facsimile data, both stored in the multi-function device communications management unit 300, may be so protected that only the authorized users may access to them.

Facsimile-related software 210 is installed in the personal computer 200. This software can enable the multi-function device communications management unit 300 to perform its function and can retrieve any data the user wants, from the facsimile communication result log or backup data memory unit of the multi-function device communications management unit 300.

The system including the multi-function device and the multi-function device communications management unit, according to the present invention, is configured as described above. A method of controlling the multi-function device and the multi-function device communications management unit in this system will be explained below, on the assumption that the printer unit 130 does not divide and print data.

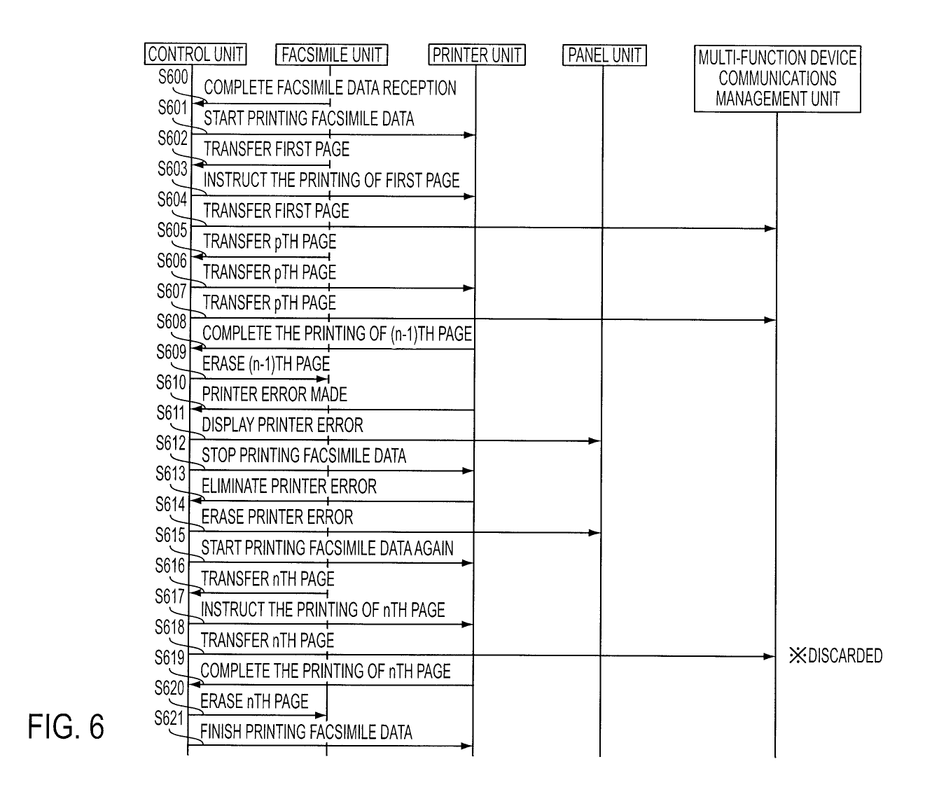

FIG. 6 is a chart that depicts a control sequence performed by the multi-function device and multi-function device communications management unit, both according to the embodiment. The sequence chart of FIG. 6 shows the control sequence that is performed in the case where the facsimile unit 120 of the multi-function device 100 receives a facsimile document data and an error occurs in the nth page while the printer unit 130 is printing the facsimile document data.

First, in Step S600, the control unit 110 of the multi-function device 100 receives a notification showing the completion of data receipt at the facsimile unit 120. Then, in Step S601, the control unit 110 instructs the printer unit 130 to start printing the facsimile document data. In Step S602, the facsimile unit 120 transmits the first page of the document data to the control unit 110. In Step S603, the control unit 110 generates and supplies an instruction to the printer unit 130, instructing the same to print the facsimile document data. In the next step, i.e., Step S604, a facsimile communication result log and backup data, both concerning the first page (hereinafter, these data items will be referred to as “facsimile backup data”) are transmitted to the multi-function device communications management unit 300.

Steps similar to Steps S602 to S604 are repeated, data is transferred from the facsimile unit 120 to the control unit 110 and thence to the printer unit 130. Thus, the data is thereby printed and the facsimile backup data is transmitted from the control unit 110 to the multi-function device communications management unit 300. (See Steps S605 to S607).

Data is erased in the facsimile memory 121 at the time the printer unit 130 finishes printing the data, as will be explained later. That is, in Step S608, the printer unit 130 informs the control unit 110 that the (n−1) th page of data has been printed. Then, the control unit 101 instructs the facsimile unit 120 to erase the (n−1)th page data stored in the facsimile memory 121.

Assume that in the present embodiment, an error develops in the printer unit 130. In this case, upon receiving the notification of the error made in the printer unit 130 in Step 610, the control unit 110 makes the panel unit 150 display the error in Step S611, prompting the user to eliminate the error. In Step S612, the control unit 110 instructs the printer unit 130 to stop printing the facsimile data.

When the user eliminates the error, the printer unit 130 informs the control unit 110 of this event in Step S613. In Step S614, the control unit 110 makes the panel unit 150 display a message showing that the printing error has been eliminated.

In Step S615, the control unit 110 instructs the printer unit 130 to resume the printing of the facsimile data. In Step S616, the control unit 110 receives the nth page of document data from the facsimile unit 120. Then, in Step S617, the control unit 110 instructs the printer unit 130 to print the nth page. In the control sequence according to this invention, the facsimile backup data of the nth page is transmitted to the multi-function device communications management unit 300 in Step S618. It should be noted that the control sequence includes a step of transmitting the facsimile backup data of the nth page to the unit 300, though this step is not shown in FIG. 6. That is, the facsimile backup data of the nth page transmitted to the unit 300 in Step S618 has already been held in the multi-function device communications management unit 300. Hence, the unit 300 is so designed that one of the two identical facsimile backup data items of the nth page is discarded after read.

Upon completing the printing of the nth page of the document data, the printer unit 130 informs the control unit 110 of the completion of the printing of the nth page in Step S619. In Step S620, the control unit 101 instructs the facsimile unit 120 to erase the nth page of the facsimile document data from the facsimile memory 121. When all document data has been printed, the control unit 110 informs the printer unit 130 that all facsimile document data has been printed in Step 621.

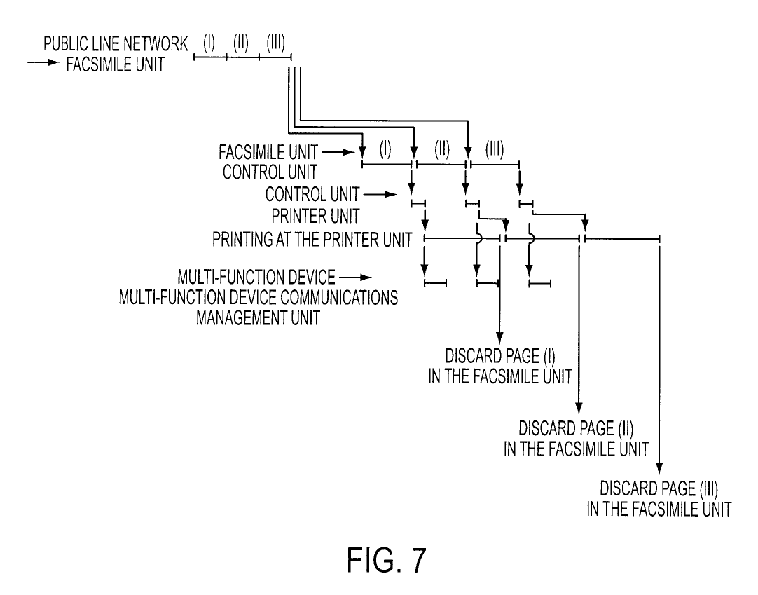

The timing of printing a three-page document consisting of pages (I), (II) and (III), by controlling the multi-function device and the multi-function device communications management unit, both according to the present invention, will be explained. FIG. 7 is a chart depicting the operation timing of the multi-function device and multi-function device communications management unit in the case where printer unit 130 makes no errors while printing the three-page document.

In FIG. 7, the uppermost stage indicates the timing of transferring data from the public line network to the facsimile unit 120 of the multi-function device 100. The second stage indicates the timing of transferring data from the facsimile unit 120 (facsimile memory 121) to the control unit 110 (control memory 111) of the multi-function device 100. The third stage indicates the timing of transferring data from the control unit 110 (control memory 111) to the printer unit 130. The fourth stage indicates the timing of transferring printing-timing data from the control unit 110 to the printer unit 130. The lowest stage indicates the timing of transferring data from the control unit 110 of the multi-function device 100 to the multi-function device communications management unit 300.

The sequence of controlling the multi-function device and the multi-function device communications management unit, both according to this invention, is a sequence that is performed in the case where the data printing at the printer unit 130 and the data saving at the multi-function device communications management unit 300 are carried out in parallel, but asynchronously.

In the control sequence according to the present invention, the page of data can be erased in the facsimile memory 121 at the time this page of data is completely printed. The multi-function device communications management unit 300 may be so configured that the facsimile backup data is discarded after it has been saved elsewhere. Then, two identical page data items would not be saved.

If the multi-function device and the multi-function device communications management unit, both according to this invention, are controlled as described above, data can be appropriately recovered (that is, only the pages not saved in the unit 300 can be saved in the device 100) even after any printing error has developed, without decreasing the speed of printing any received facsimile document (without storing the received facsimile document data on the facsimile memory 121, unnecessarily for a long time).

How the multi-function device and multi-function device communications management unit are operated while controlled in the sequence described above will be described with reference to a flowchart.

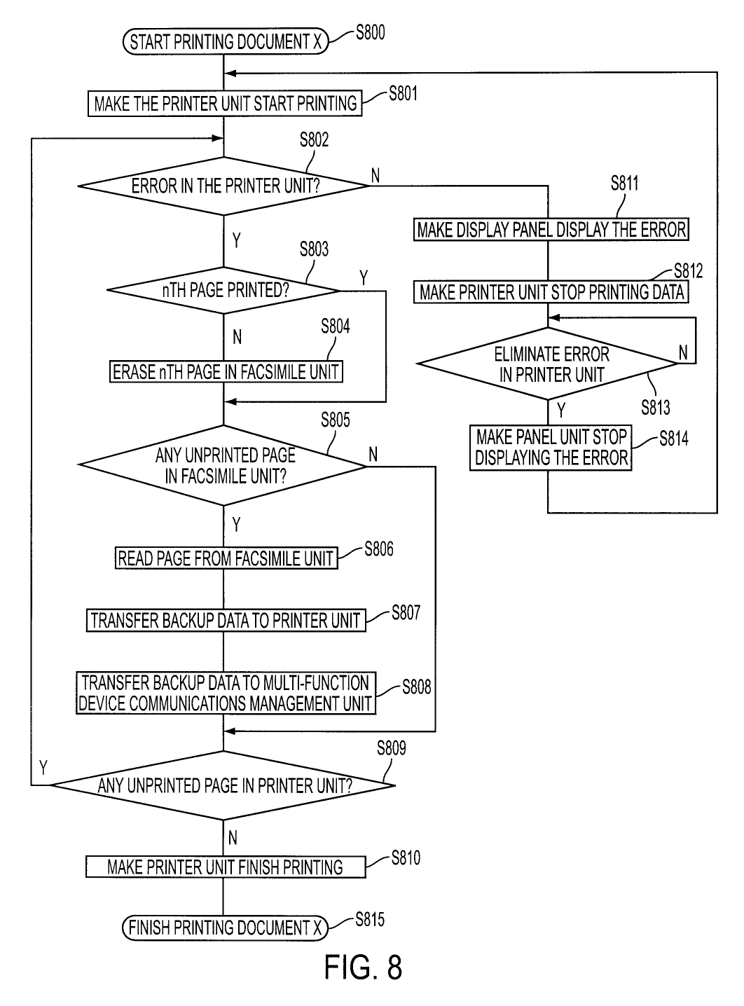

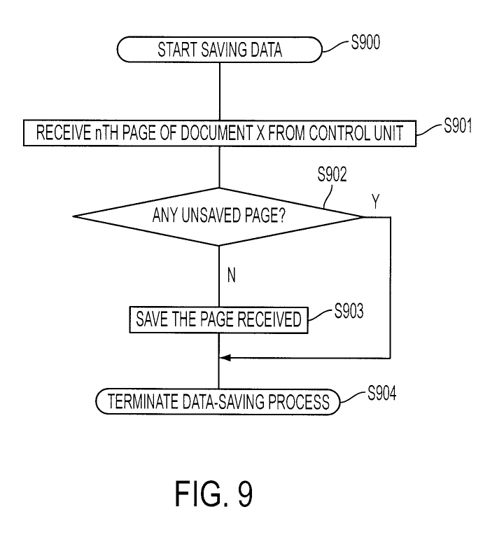

FIG. 8 is a flowchart explaining how the control unit is controlled to print a received facsimile document in the multi-function device according to this invention. FIG. 9 is a flowchart explaining a sequence of control performed to save facsimile backup data in the multi-function device communications management unit according to the present invention. With reference to these figures, how to control the multi-function device and multi-function device communications management unit will be explained.

As shown in FIG. 8, the sequence of operation is started in Step S800 after the facsimile unit 120 of the multi-function device 100 has received a facsimile document X. In Step S801, the control unit 110 instructs the printer unit 130 to start printing.

The operation goes to Step S802. In Step S802, it is determined whether the printer unit 130 has made an error. If it is determined in Step S802 that the printer unit 130 has made no errors, the operation goes to Step S803. If it is determined in Step S802 that the printer unit 130 has made an error, the operation goes to Step S811. In Step S811, the error will be eliminated.

In Step S803, it is determined whether the nth page of the facsimile document X has been printed. If it is determined in Step S803 that the nth page has not been printed, the operation goes to Step S805. If it is determined in Step S803 that the nth page has been printed, the operation goes to Step S804. In Step S804, the nth page of the document data is erased in the facsimile memory 121 of the facsimile unit 120. Thus, during the control related to the printing of the received facsimile document in the present invention, any page, if any, which has been printed, is immediately erased in the facsimile memory 121 of the facsimile unit 120.

In Step S805, it is determined whether any page of data, yet to be printed, remains in the facsimile memory 121 of the facsimile unit 120. If no pages of data to be printed remain in the memory 121, the operation goes to Step S809. In Step S805, it may be determined that a page to be printed remains in the memory 121, the operation goes to Step S806. In Step S806, the control unit 110 reads the page to be printed, from the facsimile memory 121 of the facsimile unit 120. In the next step, i.e., Step S807, the control unit 110 transfers this page to the printer unit 130. After transferring the page to the printer unit 130 in Step S807, the control unit 110 transmits the facsimile backup data to the multi-function device communications management unit 300. Thus, in the control sequence of this invention, the facsimile backup data is transmitted to the unit 300 immediately after the page data has been transmitted to the printer unit 130.

In Step S809, it is determined whether any page to be printed remains in the printer unit 130. If it is determined in Step S809 that no pages to be printed remain, the operation goes to Step S810. In Step S810, the control unit 110 generates an instruction, making the printer unit 130 stops printing. In Step S815, the process of printing the facsimile document X is terminated. If it is determined in Step S809 that any page to be printed remains in the printer unit 130, the operation returns to Step S802.

In Step S802, it may be determined that the printer unit 130 has an error. In this case, the operation goes to Step S811. In Step S811, the control unit 110 makes the panel unit 150 display a message showing that the printer unit 130 has an error. In Step S812, the control unit 110 outputs an instruction to the printer unit 130, causing the unit 130 to stop printing. Then in Step S813, it is determined whether the error has been eliminated in the printer unit 130. Until the user eliminates the error, the decision made in Step S813 remains negative (no), and Step S813 is therefore repeated. When the user eliminates the error, the decision made in Step S813 becomes affirmative (yes). In this case, the panel unit 150 stops displaying the error message and the operation returns to Step S801.

The control that the multi-function device communications management unit performs will be explained with reference to the flowchart of FIG. 9. In Step S900, the multi-function device communications management unit 300 starts saving the facsimile backup data. For the simplicity of explanation, it will not be described how to save the facsimile backup data items representing parts of data printed on separate sheets. First, in Step S901, the unit 300 receives the nth page of the facsimile backup data representing the facsimile document X from the control unit 110. Then, in Step S902 it is determined whether the nth page has not been saved. If it is determined that the page has not been saved in Step 902, the operation goes to Step S903. In Step S903, the facsimile backup data of the nth page is saved. The operation then goes to Step S904. In Step S904, the process of saving data is terminated. In Step S902 it may be determined that the page has already been saved. In this case, the operation jumps to Step S904, in which the process of saving data is terminated. Thus, only the facsimile backup data that has not been saved yet is saved in the multi-function device communications management unit 300 according to the present invention. (Any facsimile backup data item identical to another item already saved is discarded.) Hence, data can be appropriately recovered even after a printing error has developed.

As described above, the received facsimile document data is never kept unnecessarily stored in the facsimile memory 121 for a long time. The use efficiency of the memory therefore increases. Hence, the speed of printing the received facsimile document data will not be lowered.

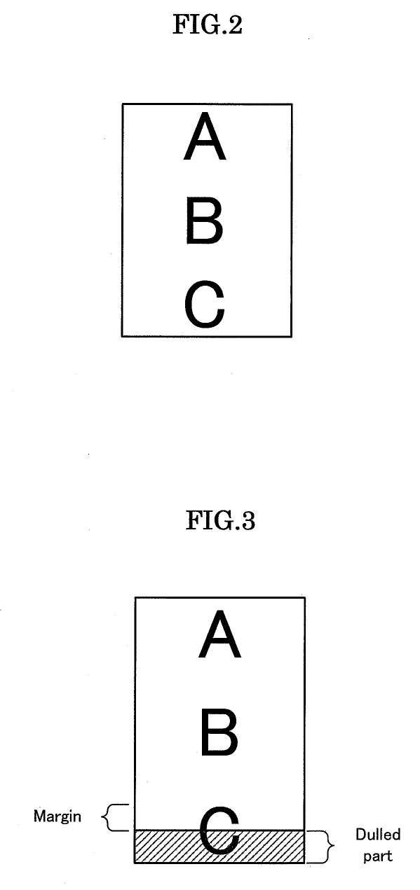

The data-reading unit of the facsimile apparatus provided at the transmission source may have a trouble, and the facsimile apparatus may inevitably transmit data that has been unnecessarily dulled. It will be explained how such data is divided into some parts and how the data parts are printed in the multi-function device 100. Paper jamming may occur in the facsimile apparatus at the transmission source. In this case, the data read from the original document may be dulled. FIG. 2 is a diagram showing an original document that will be transmitted from the facsimile apparatus provided at the transmission source. The data read from the original document may be dulled if the data-reading unit of the facsimile apparatus has a trouble as mentioned above. FIG. 3 is a diagram showing the data of the document shown in FIG. 2, which has been read in the facsimile apparatus provided at the transmission source and which has been dulled. Original document data so dulled will be hereinafter referred to as dulled data.

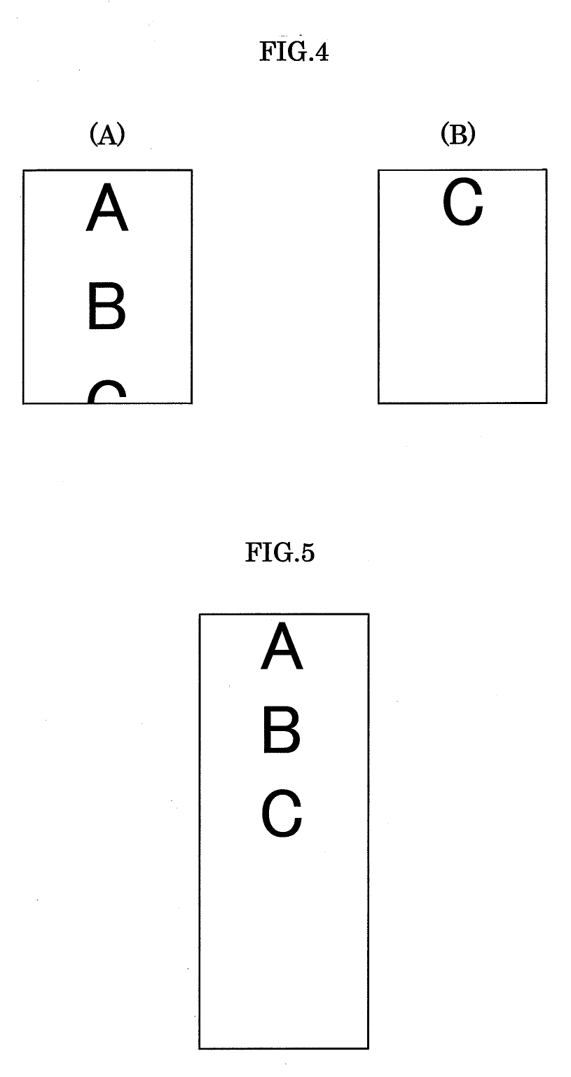

If any dulled data is received, a type of a facsimile apparatus is available, which can first divide any dulled data received, into some parts, and then printing the parts of data. The multi-function device 100 according to this invention has the function of dividing dulled data into some parts and printing the parts of data. Such as function will be described in detail. FIG. 4 is a diagram showing the two dulled data parts shown in FIG. 3 that are printed on two paper sheets A and B, respectively, in the multi-function device.

The first part of the dulled data is printed as it is, on the first paper sheet. In other words, the first page of the data, excluding the shaded part shown in FIG. 3, is printed on the first paper sheet. The fist paper sheet thus printed is sheet A shown in FIG. 4.

By contrast, the second part of the dulled data, which should be printed on the second paper sheet, includes the lower margin of the first-page data shown in FIG. 3 so that the data printed on the second paper sheet may be easy to read. That is, both the shaded part (FIG. 3) of the data and the margin part (several lines, FIG. 3) are printed on the second paper sheet.

In the case explained above, one-page data is dulled to be printed on two paper sheets. In some cases, however, one-page data may be more dulled and must therefore be printed on three or more paper sheets.

It will be discussed how such dulled data should be saved as backup data in the multi-function device communications management unit 300 if the dulled data is divided into parts and these data parts are printed on paper sheets, respectively. If the multi-function device 100 and the multi-function device communications management unit 300 are controlled in ordinary way, two backup data items will be saved in the multi-function device communications management unit 300. The two backup data items correspond to the two images A and B shown in FIG. 4, respectively. These backup data items represent such a one-page original document in the facsimile apparatus at the transmission source, as is illustrated in FIG. 2. In vies of this, it is most desirable to combine these backup data items into one backup data item and to save the resultant one back data item as electronic data that can be well read when printed on paper sheets. In addition, the two backup data items provided by dividing the one-page original document shown in FIG. 2 are hard to handle in any data-processing apparatus. In view of this, too, it is desirable to combine the two backup data items into such a backup data item as shown in FIG. 5. Backup data is thus saved in the method of controlling the multi-function device and the multi-function device communications management unit, both according to the present embodiment of this invention.

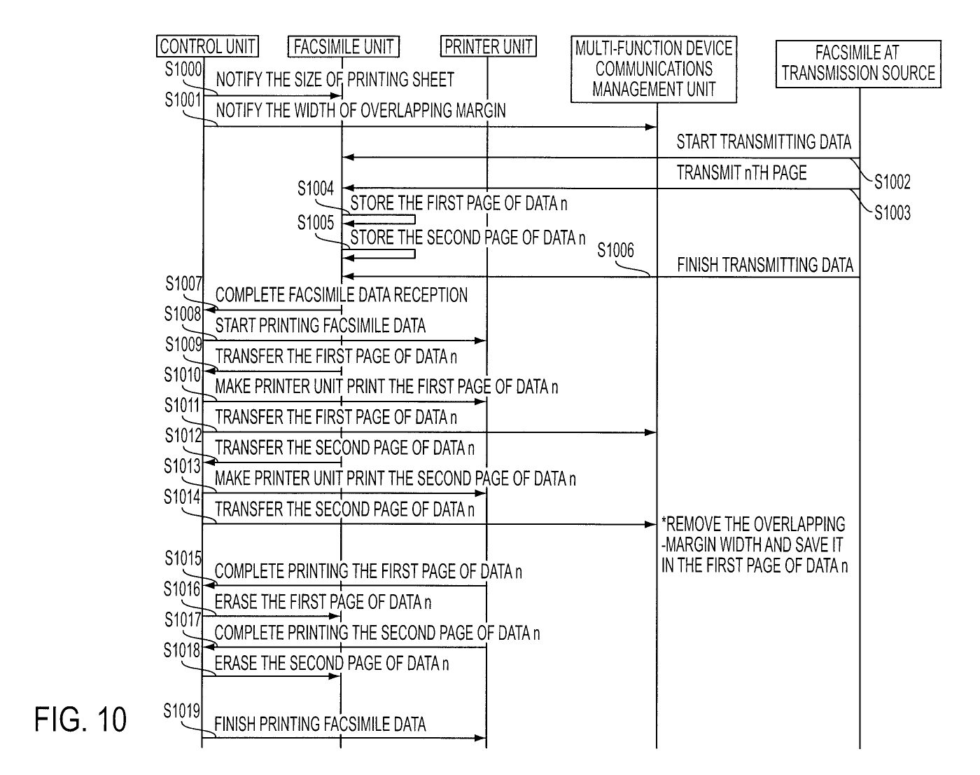

FIG. 10 is a chart depicting another control sequence performed by the multi-function device and the multi-function device communications management unit, both according to the present embodiment of this invention. Involved in the control sequence of FIG. 10 is a facsimile transmission source, as well as the control unit 110, facsimile unit 120, the printer unit 130 and the multi-function device communications management unit 300, all shown in the sequence diagram of FIG. 6. The sequence diagram of FIG. 10 relates the case where the data coming from the facsimile transmission source contains dulled data at the nth page.

In the multi-function device 100, the control unit 110 first informs the facsimile unit 120 of the size of the printing sheets in Step S1000. Then, in Step S1001, the control unit 110 informs the unit 300 of an overlapping margin. The “overlapping margin” corresponds to the “margin part (several lines)” that has been described in connection with the printing of data parts. Hereinafter the “margin part” will be also called “overlapping margin.”

In Step S1002, the transmission of facsimile data is started. In Step S1003, the nth page of the facsimile data is transmitted. The nth page must be divided into data parts before it is transmitted. Therefore, in the facsimile unit 120, the nth page is divided into data parts. In Step S1004, the first data part of the nth page is stored in the facsimile memory 121. In Step S1005, the second data part of the nth page is stored in the facsimile memory 121.

The facsimile apparatus at the transmission source may use a facsimile communications protocol that gives the multi-function device 100 the information showing that data should be divided and then printed. If this is the case, the multi-function device 100 refers to the information and stores the data parts representing the nth page. The facsimile apparatus at the transmission source may not use such a facsimile protocol. Then, the multi-function device 100 only needs to store the data parts of the nth page in the memory by the method known in the field of facsimile apparatuses.

In Step S1006, the facsimile apparatus at the transmission source informs the facsimile unit 120 that the data has all been transmitted. In Step S1007, the facsimile unit 120 informs the control unit 110 that the transmission by facsimile has been completed. Then, in Step S1008, the control unit 110 instructs the printer unit 130 to start printing the facsimile data.

In Step S1009, the facsimile unit 120 transmits the first page of document data n to the control unit 110. In Step S1010, the control unit 110 instructs the printer unit 130 to print the first page of document data n. Then in Step S1011, the control unit 110 of the multi-function device 100 transfers the facsimile backup data item that represents the first page of document data n to the multi-function device communications management unit 300.

Similarly, the facsimile unit 120 transmits the second page of document data n to the control unit 110 in Step S1012. In Step S1013, the control unit 110 instructs the printer unit 130 to print the second page of document data n. In Step S1014, the control unit 110 of the multi-function device 100 transfers the facsimile backup data item representing the second page of document data n to the multi-function device communications management unit 300. On receiving the facsimile backup data items representing the first and second pages of document data n, the multi-function device communications management unit 300 synthesizes these backup data items into backup data and stores the resultant backup data.

In Step S1015, the printer unit 130 gives the control unit 110 information showing that the first page of document data n has been printed. On receiving this information, the control unit 110 instructs the facsimile unit 120 to discard the first page of document data n from the facsimile memory 121, in Step S1016.

Similarly, in Step S1017, the control unit 110 receives from the printer unit 130 the information showing that the second page of document data n has been printed. Then, in Step S1018, the control unit 110 instructs the facsimile unit 120 to discard the second page of document data n from the facsimile memory 121. Thus, any other pages of the facsimile document data are printed. Then, the control unit 110 informs the printer unit 130 that the facsimile document has been printed, in Step S1019.

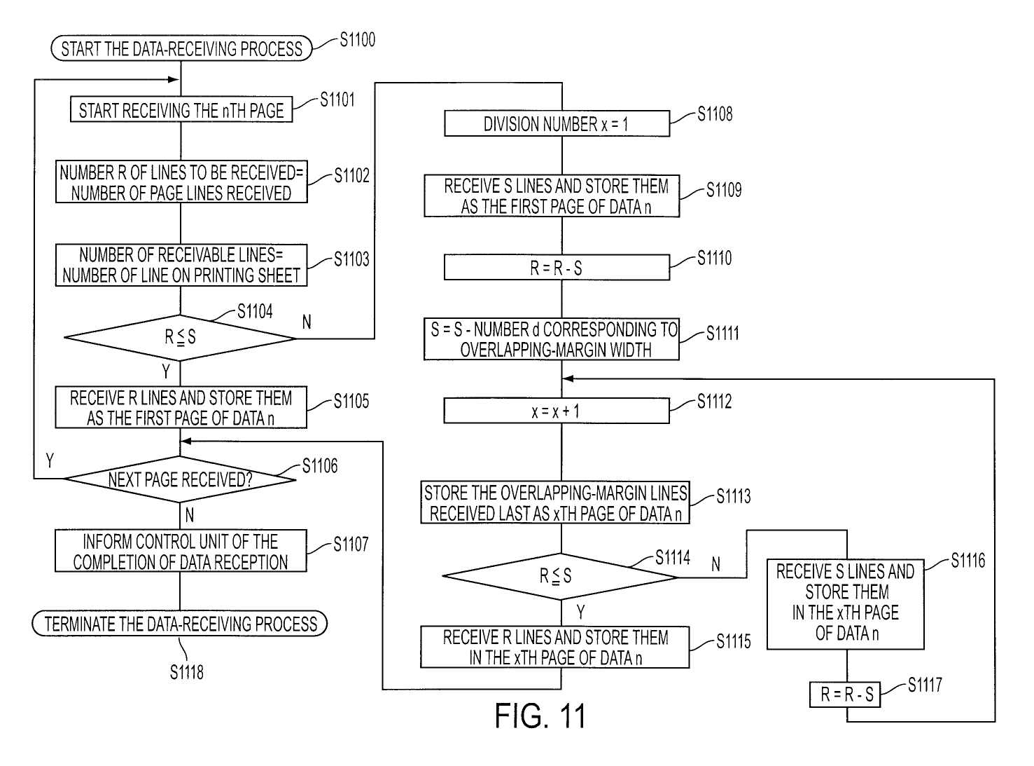

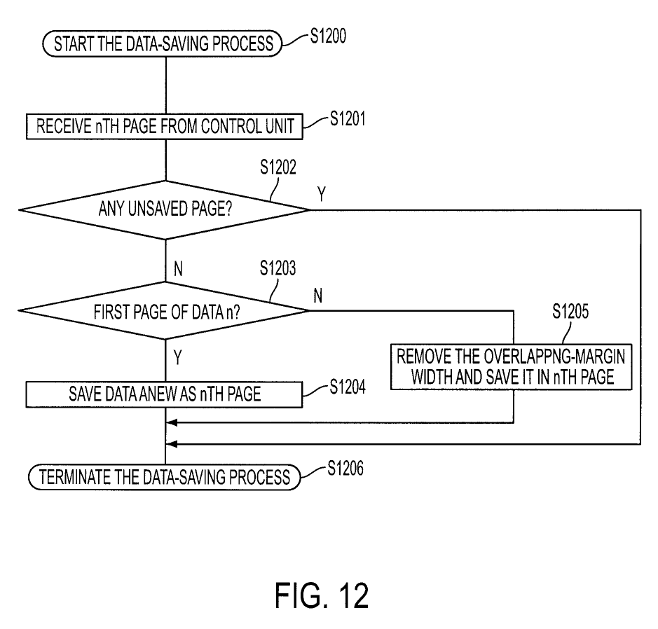

The sequence in which the multi-function device and multi-function device communications management unit, according to the present embodiment of this invention, are controlled in order to print the parts of data, will be explained with reference to the flowchart of FIGS. 11 and 12.

FIG. 11 is a flowchart explaining how the facsimile unit receives data in the multi-function device according to this invention. FIG. 12 is a flowchart explaining a sequence of control performed to save the facsimile backup data, when data is divided in the multi-function device communications management unit according to the present invention. With reference to FIGS. 11 and 12 it will be explained how the system according to this invention operates. In the data-receiving process at the facsimile unit 120 (see FIG. 11), how to store the parts of the received data in the facsimile memory 121 is an important point. Assume that the data-receiving process is performed at the facsimile unit 120 in accordance with the latest facsimile communications protocol. Also assume that the facsimile unit 120 is informed of the number of all lines when the facsimile unit 120 receives document data. If an obsolete facsimile communications protocol is used, the number of all lines used will be known after the facsimile unit 120 has received all data. In this case, the facsimile unit can be configured to perform the operation sequence shown in the flowchart of FIG. 11.

As shown in FIG. 11, the facsimile unit 120 of the multi-function device 100 starts receiving facsimile document data. That is, the data-receiving process starts in Step S1100 of the flowchart. In Step S1101, the unit 120 starts receiving the nth page. In Step S1102, a parameter “number R of remaining reception lines” is defined, and the number R is set to the number of receipt lines for receiving the nth page. In Step S1103, a parameter “number S of lines able to receive data” is defined, and the number S is set to the number of lines of printing paper sheets.

Next, in Step S1104, it is determined whether R is greater than or equal to S (R≦S). If R≦S, the operation goes to Step S1105. If R>S, the operation goes to Step S1108.

As mentioned above, the number S of lines able to receive data is the number of lines of printing paper sheets. Hence, if R≦S, the data received can be printed on one printing paper sheet. (In other words, the data need not be divided into parts before it is printed.) Therefore, in Step S1105, the data for R lines is stored as the first page of document data n.

Then, the operation goes to Step S1106, in which it is determined whether the next page of data has been received. If it is determined in Step S1106 that the next page has been received, the operation returns to Step S1101. If it is determined in Step S1106 that the next page has been received, the operation goes to Step S1107. In Step S1107, the facsimile unit 120 informs the control unit 110 that the facsimile document data has been received. In Step S1118, the facsimile unit 120 terminates the data-receiving process.

As described above, if the decision made in Step S1104 is not R≦S, the operation goes to Step S1108. Since S is the number lines able to receive data, i.e., the number of lines of printing paper sheet, it is smaller than R (i.e., R>S). This means that all data received cannot be printed on one printing paper sheet if the operation goes to Step S1108. It is therefore necessary to divide the data into parts and to print the data parts on separate paper sheets. In preparation for such data-printing, the nth page of the data must be divided into first, second, third, . . . pages of document data n, and the first, second, third, . . . pages of document data n must be stored in the facsimile memory 121.

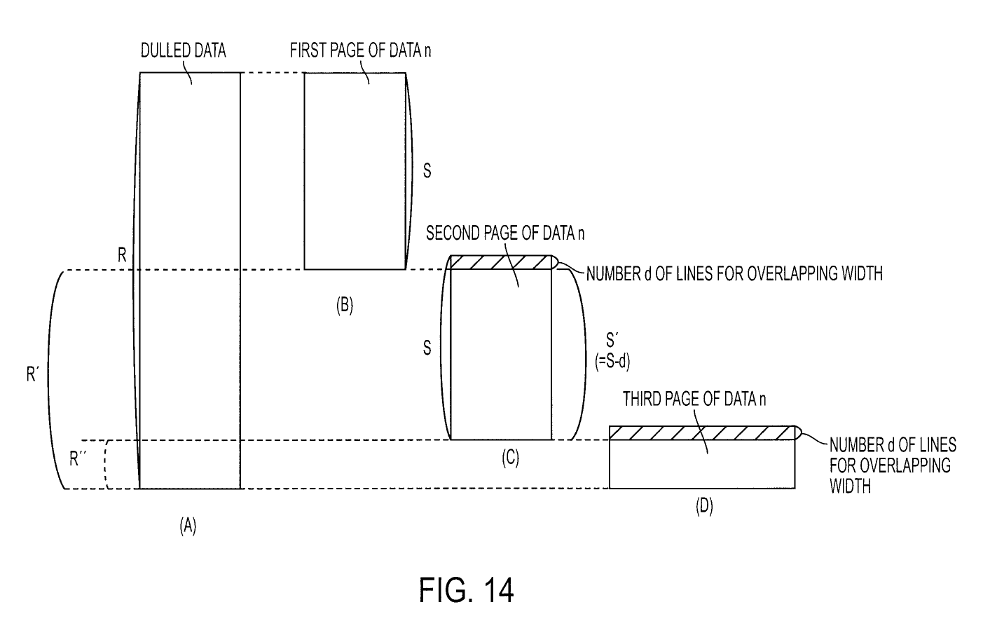

FIG. 14 is a diagram explaining the data-dividing process performed in the facsimile unit provided in the multi-function device according to the present invention. More precisely, FIG. 14 shows the case where one-page data has been dulled to 2.5-page and explains how this dulled data is divided into parts and how the resultant data parts are stored. In FIG. 14, the leftmost rectangle indicates the dulled data (A), the rectangle on the right side of the leftmost rectangle indicates the first page (B) of document data n, the rectangle on the right side of the first page (B) indicates the second page (C) of document data n, and the rightmost rectangle indicates the third page (D) of document data n. Taking the expended data shown in FIG. 14 for example, it will be described how dulled data is divided and then stored, with reference to the flowchart of FIG. 11.

Assume that the decision made in Step S1104 is not R≦S and that the operation therefore goes to Step S1108. Then, the parameter defined by division number x is set to 1. Division number x shows the number of parts into which the nth page should be divided.

Next, the operation goes to Step S1109. In Step S1109, the facsimile unit 120 receives data S that represents the number of lines of printing paper sheet. Data S is stored in the facsimile memory 121, as the first page of document data n, as is illustrated at (B) in FIG. 14. The pages following the first page must be stored in the facsimile memory 121, after an overlapping margin defined above has been added to each.

In the next step, i.e., Step S1110, the calculation of R=R−S is performed. In the case of FIG. 14, the value of R−S is given as R′. Then, in Step S1111, the calculation of S=S−d, where d is the number of lines corresponding to the overlapping margin. In the case shown in FIG. 14, the result of this calculation is given as S′. The operation then goes to Step S1112, in which division number x is incremented by one. In Step S1113, the overlapping margin (several lines) received last is stored as xth page of document data n. At this state, x=2 and the overlapping margin received last is the shaded part of the page (C), in the case shown in FIG. 14. In Step S1113, too, the data that corresponds to this shaded part is stored in the storage area for the second page of document data n.

Then, in Step S1114, it is determined whether R is greater than or equal to S (R≦S). If R≦S, the operation goes to Step S1115. If R>S, the operation goes to Step S1116.

Taking the expended data shown in FIG. 14 for example, R is not greater than or equal to S at the time only the first page of document data n is stored. Therefore, the operation goes to Step S1116. In Step S1116, the facsimile unit 120 receives data for S lines, and this data is added to the xth page of document data n. In the case of FIG. 14, that part of data, which is indicated as S′ following the shaded part of the page (C), is added and stored. Next, in Step S1117, the calculation of R=R−S is performed. In the case of FIG. 14, the result of this calculation is indicated as R″.

In the case shown in FIG. 14, the operation then returns to Step S1112. In Step S1112, division number x is incremented by one. In the case shown in FIG. 14, the number x is 3, i.e., x=3, at this stage. In the next step, i.e., Step S113, the overlapping margin (several lines) received last is stored as xth page of document data n. At this stage, x=3, and the overlapping margin received last is the shaded part of the page (D), in the case shown in FIG. 14. In Step S1113, the data corresponding to this shaded part is stored in the memory area for the third page of document data n.

Next, in Step S1114 it is determined whether R is greater than or equal to S (R≦S). In the case shown in FIG. 14, the condition of R≦S is satisfied when the second page of document data n is stored. Therefore, the operation goes to Step S1115. In Step S115, R lines are received and stored in the xth page of document data n. In the case shown in FIG. 14, the lines corresponding to R″ that follows the shaded part of the page (D) shown in FIG. 14 are stored in the memory area for the third-page of document data n. The operation goes from Step S1115 to Step S1106, in which it is determined whether the next page has been received. Thereafter, the operation proceeds as described above.

How data is saved in the multi-function device communications management unit 300 will be explained with reference to FIG. 12. FIG. 12 is a flowchart explaining a sequence of control performed to save the facsimile backup data, when data is divided in the multi-function device communications management unit according to this invention.

In Step S1201, the unit 300 receives the facsimile backup data representing the nth page of facsimile document X from the control unit 110. In Step S1202, it is determined whether the nth page of the facsimile document X has been saved. If the nth page has not been saved, the operation goes to Step S1203. If it is determined that the nth page has been saved, the operation goes to Step S1206, in which the data-saving process is terminated.

In Step S1203, it is determined whether the data is the first page of document data n. If Yes in Step S1203, the operation goes to Step S1204, in which the data is saved as nth page. If No in Step S1203, the operation goes to Step S1205. In Step S1205, the overlapping margin is eliminated from the data and the data is saved as nth page. Next, the operation goes to Step S1206, in which the data-saving process is terminated.

Taking the expended data shown in FIG. 14 for example, it will be explained how the facsimile backup data is saved as shown in the flowchart of FIG. 12. In FIG. 14, (B) is the facsimile backup data representing the first page of document n, (C) is the facsimile backup data representing the second page of document n, and (D) is the facsimile backup data representing the third page of document n. Assume that the backup data represented by the left most rectangle is generated form these facsimile backup data items. Then, the data corresponding to number d of lines or the overlapping margin indicated as the shaded part, is unnecessary in order to synthesize the facsimile backup data items (B), (C) and (D). This data is therefore eliminated in Step S1205 shown in the flowchart of FIG. 12.

As described above, the present invention can save data printed in a divided form as one-page data in the multi-function device communications management unit 300.

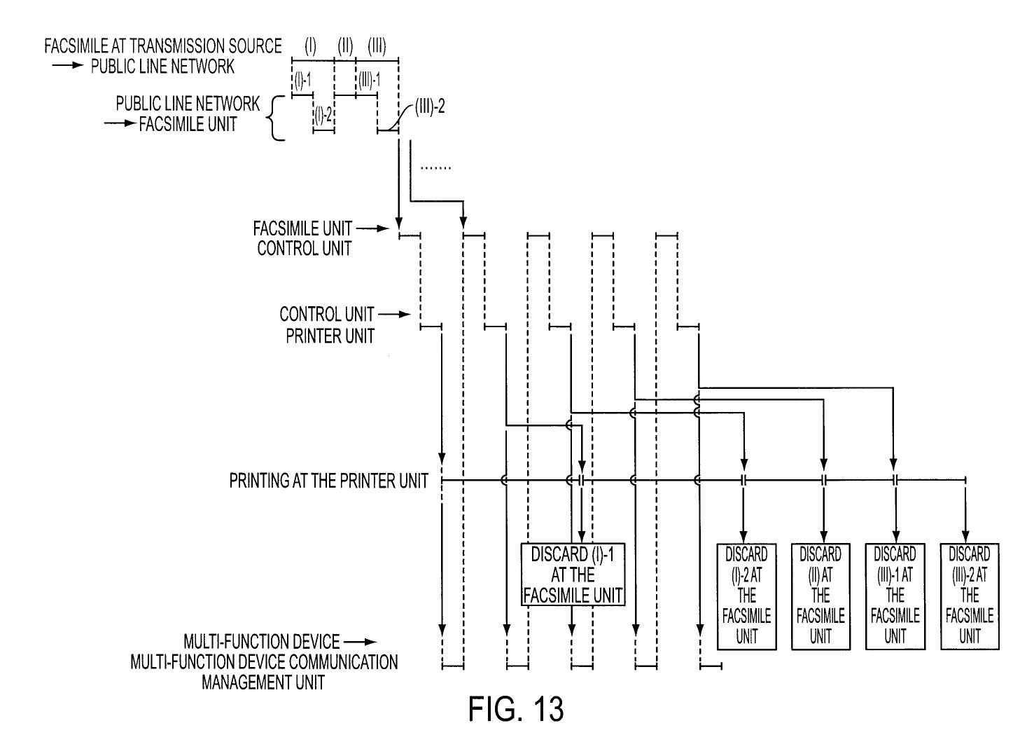

The timing of printing the transmitted data consisting of pages (I), (II) and (III), in the sequence of operations controlled by the multi-function device and multi-function device communications management unit, both according to this invention, will be explained with reference to FIG. 13. FIG. 13 is a chart depicting the timing of the operations performed under the control of the multi-function device and the multi-function device communications management unit, both according to the embodiment of the invention. FIG. 13 shows the case where the pages (I), (II) and (III) are dulled in the facsimile apparatus at the transmission source and these pages are divided and printed in the multi-function device.

In FIG. 13, the uppermost stage indicates the timing of transferring data from the facsimile apparatus at the transmission source to the public line network. The second stage indicates the timing of transferring data from the public line network to the facsimile unit 120 (facsimile memory 121) of the multi-function device 100. The third stage indicates the timing of transferring data from facsimile unit 120 (facsimile memory 121) of the multi-function device 100 to the control unit 110 (control memory 111). The fourth stage indicates the timing of transferring printing-timing data from the control unit 110 (control memory 111) to the printer unit 130. The lowermost stage indicates the timing of transferring printing-timing data from the control unit 110 of the multi-function device 100 to the multi-function device communications management unit 300.

As has been described, the document data received by facsimile is not unnecessarily long held in the memory of the facsimile unit in the present invention. The use efficiency of the memory therefore increases. Hence, the speed of printing the received facsimile document data will not be lowered. Further, in the present invention, the data printed in a divided form can be saved as one-page data in the multi-function device communications management unit.

What is claimed is:

1. A multi-function device system comprising a multi-function device and a multi-function device communications management unit, wherein the multi-function device is connected to a network and has a facsimile function and the multi-function device communications management unit is connected to the same network and saves the backup data of document data the multi-function device has received by facsimile; the multi-function device is controlled to divide the document data received by facsimile as one-page data, into a plurality of pages and to print these pages, when the documents data is too large to print on one page; and the multi-function device communications management unit is controlled to save the backup data of a plurality of pages transmitted from the multi-function device, as one-page backup data.

2. The multi-function device system according to claim 1, wherein data related to an overlapping margin exists at the head of the data following the second page of the plurality of pages.

3. The multi-function device system according to claim 2, wherein the multi-function device gives information about the width of the overlapping margin to the multi-function device communications management unit.

4. The multi-function device system according to claim 2, wherein the multi-function device communications management unit performs a control, thereby removing the data about the overlapping margin from the backup data of the plurality of pages transmitted from the multi-function device and then saving the backup data as one-page backup data.

5. The multi-function device system according to claim 2, wherein the multi-function device communications management unit performs a control, thereby saving only that part of the backup data, which has not been saved.

6. The multi-function device system according to claim 2, wherein when a printing error occurs in the multi-function device, a printing process and a process of transmitting the backup data to the multi-function device communications management unit are interrupted.

7. The multi-function device system according to claim 6, wherein when the printing error is eliminated in the multi-function device, the printing process and a process of transmitting the backup data to the multi-function device communications management unit are resumed from pages of data to be printed.

8. A multi-function device connected to a network, in which when document data received as one page is too large to print on one page, the document data is printed as a plurality of pages, data about the overlapping margin is set at the head of the data following the second page, and the backup data of the plurality of pages is transmitted, together with the data about the margin, to a multi-function device communications management unit connected to the same network.

9. The multi-function device according to claim 8, which gives information about the width of the overlapping margin to the multi-function device communications management unit.

10. A multi-function device communications management unit which receives information about the width of a overlapping margin from a multi-function device and removes data about the overlapping margin from the backup data of a plurality of pages transmitted from the multi-function device, thereby saving the backup page of one page, said multi-function device being configured to receive document data by facsimile as one page, to print the document data as a plurality of pages when the document data is too large to print on one page, to set data about the overlapping margin at the head of the data following the second page, and to transmit the backup data of the plurality of pages,
